(19) United States
(12) Patent Application Publication
(10) Pub. No.: US 2014/0049218 A1
(43) Pub. Date: Feb. 20, 2014

(54) SYSTEM FOR CHARGING AN ELECTRIC OR HYBRID VEHICLE

(71) Applicants: Nicolas Morand, Courbevoie (FR); Serge Da Cruz Pereira, St. Ouen L Aumone (FR); Aurelien Maudemain, St. Germain Les Arpajon (FR)

(72) Inventors: Nicolas Morand, Courbevoie (FR); Serge Da Cruz Pereira, St. Ouen L Aumone (FR); Aurelien Maudemain, St. Germain Les Arpajon (FR)

(73) Assignee: PEUGEOT CITROEN AUTOMOBILES SA, Velizy Villacoublay (FR)

(21) Appl. No.: 14/008,974

(22) PCT Filed: Mar. 26, 2012
(86) PCT No.: PCT/FR2012/050626

§ 371 Date: Oct. 31, 2013

(30) Foreign Application Priority Data
Apr. 6, 2011 (FR) 1152999

(51) Int. Cl. B60L 11/18

(52) U.S. Cl. CPC B60L 11/1824
USPC 320/109; 320/137

(57) ABSTRACT

The invention relates to a System for charging an electric or hybrid vehicle (10), including: an AC charging connecter (12) that is connectable to a domestic power-distribution network via an electrical-connection outlet (4) having a température-sensative device (8); and a processing means (20, CAN, UT) for determining whether or not to use a domestic charging mode (mode 1), characterized in that the System also includes a means (SP, RP) for polarizing the temperature-sensitive device which is activated when a domestic charging mode is used, and a means (24) for determining a value representing the température of the electrical-connection outlet by means of the polarized temperature-sensitive device.

### CROSS-REFERENCE TO RELATED APPLICATIONS

This application is the US National Stage under 35 U.S.C. §371 of International Application No. PCT/FR2012/050626 which was filed on Mar. 26, 2012 and which claims priority to French Pat. App. No. 1152999 which was filed on Apr. 6, 2011.

### BACKGROUND

The present invention relates generally to the safety of users of electric and hybrid vehicles which are charged by connecting them to an electrical network. More particularly, the present invention relates to electric or hybrid vehicles the charging of which can be carried out in particular on a private electrical system or a home network.

In order to standardize the different charging methods for this type of vehicle, the draft standard IEC 61851-1 recommends a charging system at the vehicle level which must communicate with the power distribution network via a line called a pilot line through an AC charging connector imposing, according to the charging mode used, for example, in the Mode 3 defined in this project, a number of additional functions by means of a control circuit called a “pilot circuit.”

The first charging mode, called “Mode 1”, defined in this draft standard, corresponds to the charging of an electric or hybrid vehicle on a private electrical system or a home network. This charging mode poses the particular problems of requiring significant power for a long period of time which can cause, over repeated use, overheating of certain elements, such as the electrical outlet to the network.

Although devices to protect electrical outlets against overheating that can cause burns to a user manipulating such outlets, or fire in case of excessive overheating, are known in the prior art, these devices are not adapted to a charging system as recommended by current standards. As an example, the document DE 3331847, which shows an electrical outlet equipped with a bimetallic element breaking the circuit if the outlet gets hot, is not suited to a charging system allowing charging according to various modes via a pilot line.

### BRIEF SUMMARY

An object of the present invention is to address the drawbacks of the prior art mentioned above and, in particular, to first propose a secure charging system for charging on a home power distribution network.

For this purpose, a first aspect of the invention relates to a system for charging an electric or hybrid vehicle including an AC charging connector that is connectable to a home power distribution network via an electrical outlet having a temperature sensitive device and processing means for determining whether or not a home charging mode is being used. The charging system also includes polarizing means for polarizing the temperature sensitive device, which is activated when a home charging mode is used, and means for determining a value representative of the temperature of the electrical outlet by means of the polarized temperature sensitive device. Such a charging system allows detecting if the charging mode used is a home charging mode (i.e. Mode 1, according to the draft standard IEC 6 1851-1), and, in this case, securing the charging by controlling the temperature of the electrical outlet during charging through the use of polarizing means to monitor the evolution of the temperature sensitive device integrated into the outlet. This charging system is particularly suitable for older or antiquated electrical installations, and/or when inappropriate extension cords are being used, inasmuch as it helps prevent overheating at the site of the connection outlet to the home distribution network. Furthermore, such a charging system proves to be economically viable to the extent that the additional cost for its implementation is low.

According to an advantageous embodiment, the charging connector and the electrical outlet are connected by a transmission means comprising a ground wire and at least one pilot wire forming a pilot line. The use of such a pilot line ensures a standardized communication between the distribution network and the charging system of the vehicle so as to allow, in particular, charging the vehicle in Mode 1 or Mode 3, as defined in the draft standard IEC 61851-1.

According to another advantageous embodiment, the charging system is further provided a pilot circuit connected to the pilot line to ensure the compatibility of the charging system with charging modes other than the home charging mode. The incorporation of such a pilot circuit allows complying with current standards imposing additional duties to charging systems in order to allow charging in different modes. So, for example, in order to comply with the draft standard IEC 61851-1, the pilot circuit is able to check the connection of the vehicle to a power distribution network, to continuously check the integrity of a protective ground connection, to energize or de-energize the charging system and to select a charging rate.

According to another advantageous embodiment, the polarizing means comprises a polarizing source in series with a polarizing resistor. The polarizing source is preferably a voltage source so as to simply perform the polarization of the temperature sensitive device through the polarizing resistor.

In an advantageous embodiment, wherein the pilot circuit includes means for blocking the passage of current, the polarizing source is a negative polarizing source which activates the blocking means of the pilot circuit. The use of a negative polarizing source allows avoiding disturbances of the temperature measurement that may be caused by elements of the charging system, such as the pilot circuit, by using the blocking means of the pilot circuit.

According to another advantageous embodiment, activation of the polarizing means is powered by a switch arranged on the polarizing circuit of the pilot line by placing the polarizing source and resistor in series, for example, in series between said source and said polarizing resistor. The switch is controlled by determining whether or not a home charging mode is being used so as to implement the polarizing means only when it is needed.

According to another advantageous embodiment, the means for determining a value representative of the temperature of the electrical outlet is identical to the processing means for determining whether or not a home charging mode is being used. Reusing the same means for two different functions allows reducing the components that the charging system needs and, as a result, the cost of its implementation.

According to another advantageous embodiment, cut-off means for interrupting the charging is activated when the representative value of the electric outlet temperature is determined to be greater than a predetermined threshold. This cut-off means ensures the safety of the charging and of the user upon detection of overheating at the outlet by interrupting the charging so as to prevent overheating of the electrical outlet that may be handled manually and a risk of fire due to overheating.

According to a second aspect, the invention relates to an electric or hybrid vehicle including a charging system according to the first aspect.

According to a third aspect, the invention relates to a method for charging an electric or hybrid vehicle according to the second aspect, connected to a home power distribution network via an electrical outlet equipped with a temperature sensitive device. In accordance with this aspect, the method comprises the steps of: (i) detecting the connection of the AC charging connector to a power distribution network; (ii) determining whether a home charging mode is being used; (iii) polarizing the temperature sensitive device of the electrical outlet when the charging mode used is a home charging mode; and (iv) determining a value representative of the temperature of the electrical outlet by means of the polarized temperature sensitive device. In a variant embodiment, steps (i) and (ii) can be reversed.

### DESCRIPTION OF THE FIGURES

Other features and advantages of the present invention will become more apparent upon reading the following detailed description of embodiments of the invention given by way of non-limiting examples and illustrated in the accompanying drawing, in which:

FIG. 1 shows schematically, in the form of functional blocks, a charging system connected via a pilot line and an electrical outlet to a power distribution network according to an embodiment of the invention.

### DETAILED DESCRIPTION

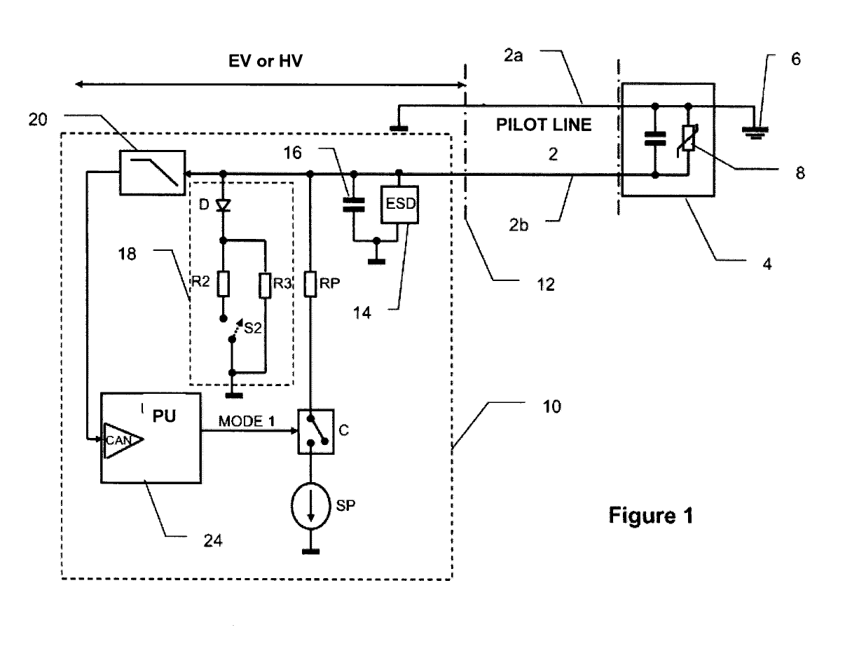

As can be seen in FIG. 1, an electric or hybrid vehicle, corresponding to the part designated by EV or HV, is connected to a power distribution network via a pilot line 2 and an electrical outlet 4. The electrical outlet is grounded 6 at the charging point.

The electrical outlet 4 comprises a temperature sensitive device 8 that can be realized, for example, by means of a thermistor, as shown, or also by means of a bimetallic element, possibly in series with a resistor. The outlet may also include a capacitor or an equivalent device mounted in parallel and/or in series with the temperature-sensitive device 8 in order to protect it against transient disturbances.

The pilot line 2 connects the electrical outlet 4 to a charging system 10 of the electric or hybrid vehicle (EV or HV). The pilot line 2 serves as a means of transmission between the charging system 10 and the power distribution network. This pilot line comprises a ground wire 2a connecting the ground 6 to one end of the temperature sensitive device and to a reference potential of the vehicle, and at least one wire 2b, called “pilot,” connecting the other end of the temperature sensitive device to the vehicle. The pilot wire 2b is connected to the charging system to allow communicating with the temperature sensitive device, while in Mode 3, it would allow communicating with the charging point connected to the power distribution network.

To charge the battery (or batteries) of the electric or hybrid vehicle, the charging system 10 includes a charging connector 12 which is provided at the input of the charging system for connecting the pilot line 2 to the electrical outlet 4. The charging connector 12 is an AC connector allowing, in Mode 1, to connect to a home network delivering an alternating current. It should be noted, in passing, that the mass of the charging system is equipotential with the ground through the ground wire 2a.

It is preferably planned to provide the charging system with means of protection 14 against electrostatic discharges (ESD), for example, mounted as in parallel and/or in series on the pilot wire 2b. The pilot wire 2b can also affect the charging system 10 of the vehicle through a capacitor 16, or equivalent device, mounted as in parallel and/or in series with the means of protection 14 against electrostatic discharges (ESD) (as shown) and against transient disturbances.

It is also planned to provide the charging system 10 with a circuit called a pilot circuit 18. This pilot circuit includes a diode D, resistors R2 and R3, and a switch S2. Their connection modes are defined by the draft standard IEC 61851-1. The function of this pilot circuit is to confirm the connection of the vehicle to the charging point of a power distribution network, to continuously confirm the integrity of a protective ground connection, to energize or de-energize the charging system and to select a charge rate so as to provide the additional functions required for a charging mode (i.e. Mode 3) other than the home charging mode, or Mode 1, defined in the above mentioned draft standard.

The pilot wire 2b can then activate a processing means comprising, for example, a low-pass filter whose output is connected to an analog digital converter (CAN) whose output is itself connected to a processing unit (PU). The processing unit may be, for example, a microcontroller, a microprocessor, an erasable programmable logic device (EPLD) or a combination of several of these electronic components and/or equivalent components. The processing unit provides a boolean variable type logical information (designated as “Mode 1”), indicating, when it is true, that the current charging is done by direct connection to an electrical outlet on a local home network, as defined by the draft standard IEC 61851-1.

Finally, the charging system includes polarizing means preferably comprising a polarizing source SP in series with a polarizing resistor RP. These polarizing means are launched by a switch C activated by the “Mode 1” boolean information. The function of the polarizing means is to polarize the temperature sensitive device 8 to a predetermined voltage by the polarizing source SP via the resistor RP, this taking place only when said “Mode 1” boolean information is true. The polarizing source is advantageously a source of negative voltage, for example, −12V with respect to ground.

We will now explain how the charging system operates according to the embodiment shown in FIG. 1.

When the charging of the vehicle via a distribution network does not occur in home mode, or Mode 1, according to the draft standard IEC 61851-1, the Mode 1 signal controls switch C so that it stays open, the polarizing means having therefore no effect.

Alternatively, when the charging is done in domestic mode, or Mode 1, according to the draft standard IEC 61851-1, the Mode 1 signal controls switch C so that it stays closed. As a result, the temperature sensitive device is polarized by the polarizing source SP via the resistor RP. Following this polarization, a value representative of the temperature from the polarized temperature sensitive device, and thus the temperature of the electrical outlet, can be determined by a processing unit, preferably the same as that used for determining the charging mode. This representative value of the temperature can be determined by any suitable method, including an algorithm and possibly appropriate specific software(s), possibly using, as shown, the same low-pass filter and the same analog digital converter as for the analysis of the pilot line in Mode 3.

Finally, it should be noted that the use of a negative polarizing source SP of the temperature sensitive device allows preventing the pilot circuit, in particular the components D, R3, and possibly R2, from disturbing the measurement of the electrical outlet temperature because diode D blocks most of the current flow when the voltage of the pilot wire is negative.

It will be understood that various modifications and/or improvements obvious to one skilled in the art may be made to the various embodiments of the invention described herein without departing from the scope of the invention defined by the appended claims.

1. A charging system of an electric or hybrid vehicle, comprising an AC charging connector suitable for being connected to a home power distribution network via an electrical outlet equipped with a temperature sensitive device, processing means for determining whether or not a home charging mode (Mode 1) is being used, means for polarizing the temperature sensitive device, said polarizing means being activated when a home charging mode is used, and means for determining a value representative of the temperature of the electrical outlet using the polarized temperature sensitive device.

2. The charging system according to claim 1, wherein the charging connector and the electrical outlet are connected by transmission means comprising a pilot line comprising a ground wire and at least one pilot wire.

3. The charging system according to claim 2, further comprising a pilot circuit connected to the pilot line to ensure compatibility of the charging system with charging modes other than the home charging mode (Mode 1).

4. The charging system according to claim 1, wherein the polarizing means comprises a polarizing source in series with a polarizing resistor.

5. The charging system according to claim 3, wherein the pilot circuit comprises means for cutting off current flow, and the polarizing source is a negative polarizing source which activates the cut-off means of the pilot circuit.

6. The charging system according to claim 4, including a switch arranged on the polarizing circuit of the pilot line and switchable between a closed position in which the polarizing source and the polarizing resistor are connected in series and an open position in which the line between the polarizing source and polarizing resistor is open; said polarizing means being activated when said switch is in its closed position.

7. The charging system according to claim 1, wherein the means for determining a value representative of the temperature of the electrical outlet and the processing means for determining whether a home charging mode (Mode 1) is being used share the same processing unit.

8. The charging system according to claim 1, further comprising means for interrupting the charging; said charging interrupting means being activated when the representative value of the temperature of the electrical outlet is determined to be greater than a predetermined threshold.

9. An electric or hybrid automobile vehicle comprising a charging system according to one of claim 1.

10. A method of charging an electric or hybrid vehicle comprising a charging system according to claim 1, wherein the vehicle is connected to a home power distribution network via an electrical outlet equipped with a temperature sensitive device, the method comprising the steps of:
detecting the AC connection of the charging connector to a power distribution network;
determining whether a home charging mode is being used (Mode 1);
polarizing the temperature sensitive device of the electrical outlet if it is determined that the charging mode being used is a home charging mode; and
determining a value representative of the temperature of the electrical outlet by means of the polarized temperature sensitive device.

11. The method of claim 10 further comprising a stop of interrupting the charging of the vehicle if the value representative of the temperature of the electrical outlet exceeds a predetermined value.
